(19) United States
(12) Patent Application Publication
(10) Pub. No.: US 2023/0112132 A1
(43) Pub. Date: Apr. 13, 2023

(54) STORAGE MEDIUM, DATABASE CONSTRUCTION METHOD, AND INFORMATION PROCESSING APPARATUS

(71) Applicant: FUJITSU LIMITED, Kawasaki-shi (JP)

(72) Inventor: Masayuki Hiromoto, Kawasaki (JP)

(73) Assignee: FUJITSU LIMITED, Kawasaki-shi (JP)

(21) Appl. No.: 17/831,464

(22) Filed: Jun. 3, 2022

(30) Foreign Application Priority Data
Oct. 7, 2021 (JP) 2021-165560

(51) Int. Cl. G06F 40/30; G06N 5/02; G06N 5/04; G06F 40/205; G06V 10/82

(52) U.S. Cl. CPC G06F 40/30; G06N 5/022; G06N 5/041; G06F 40/205; G06V 10/82

(57) ABSTRACT

A non-transitory computer-readable storage medium storing a database construction program that causes a computer to execute a process that includes analyzing an input image or text to generate a semantic representation including a plurality of subgraphs defining relationships between a plurality of first parts of speech and a plurality of second parts of speech; extracting, from a plurality of subgraphs stored in a database, third parts of speech having relationships with the first parts of speech included in the plurality of subgraphs of the semantic representation; generating first knowledge including a plurality of subgraphs in which the first parts of speech in the plurality of subgraphs of the semantic representation are replaced with the third parts of speech; and registering, in the database, a remaining subgraph obtained by removing a contradictory subgraph from the plurality of subgraphs included in the first knowledge based on the semantic representation and the database.

### CROSS-REFERENCE TO RELATED APPLICATION

This application is based upon and claims the benefit of priority of the prior Japanese Patent Application No. 2021-165560, filed on Oct. 7, 2021, the entire contents of which are incorporated herein by reference.

### FIELD

Embodiments discussed herein are related to a storage medium, a database construction method, and an information processing apparatus.

### BACKGROUND

In recent years, a neural network (NN) is actively used in fields such as syntax analysis and image recognition. For example, use of deep learning (DL) has significantly improved accuracy of syntax analysis and image recognition.

In many types of current machine learning, training is performed by using training data corresponding to a task. Meanwhile, when a person performs syntax analysis or image recognition, the person makes determination by using “common sense” in addition to training for each task. Accordingly, using common sense is considered to be useful also in machine learning.

As a base technique of common sense usage in the related art, there is a technique in which NN and hyper dimensional computing (HDC) are combined, the HDC being one of non-von Neumann computing techniques focusing on information representation in the brain. This enables acquiring and using of common sense from a common sense database (DB) and expressing of knowledge as a hyperdimensional vector (HV) in syntax analysis and image recognition.

FIG. 12 is a diagram illustrating an example of the common sense DB. The common sense DB is a collection of common sense in a graph format, and is represented as sets each having a triple as elements. For example, a format of the common sense DB is (“subject”, “predicate”, “object”). “Subject” represents a matter to be a subject, “object” represents a matter to be an object, and “predicate” represents a relationship between these matters. For example, a graph 5 of FIG. 12 includes triples such as (“human”, “CapableOf”, “draw”) and (“draw”, “RelatedTo”, “picture”). Data to be registered in the common sense DB is manually collected.

U.S. patent Ser. No. 10/740,398 and Japanese Laid-open Patent Publication No. 2013-175097 are disclosed as related art.

### SUMMARY

According to an aspect of the embodiments, a non-transitory computer-readable storage medium storing a database construction program that causes at least one computer to execute a process, the process includes analyzing an input image or text to generate a semantic representation including a plurality of subgraphs defining relationships between a plurality of first parts of speech and a plurality of second parts of speech; extracting, from a plurality of subgraphs stored in a database, third parts of speech having relationships with the first parts of speech included in the plurality of subgraphs of the semantic representation; generating first knowledge including a plurality of subgraphs in which the first parts of speech in the plurality of subgraphs of the semantic representation are replaced with the third parts of speech; and registering, in the database, a remaining subgraph obtained by removing a contradictory subgraph from the plurality of subgraphs included in the first knowledge based on the semantic representation and the database.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of common sense reasoning according to a related art;

FIGS. 2A and 2B are diagrams for explaining an HV;

FIG. 3 is a diagram illustrating a configuration example of an information processing apparatus according to Embodiment 1;

FIG. 4 is a diagram illustrating an example of a semantic graph and subgraphs according to Embodiment 1;

FIG. 5 is a diagram illustrating an example of a scene graph according to Embodiment 1;

FIG. 6 is a diagram illustrating an example of an overall configuration of output process according to Embodiment 1;

FIG. 7 is a diagram (1) illustrating an example of construction process according to Embodiment 1;

FIG. 8 is a diagram (2) illustrating the example of the construction process according to Embodiment 1;

FIG. 9 is a diagram (3) illustrating the example of the construction process according to Embodiment 1;

FIG. 10 is a flowchart illustrating an example of a flow of the construction process according to Embodiment 1;

FIG. 11 is a diagram for explaining a hardware configuration example; and

FIG. 12 is a diagram illustrating an example of a common sense DB.

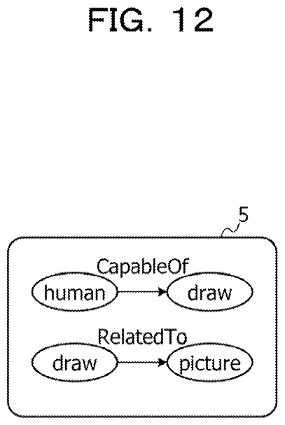

### DESCRIPTION OF EMBODIMENTS

In the related art described above, there is a problem that a new graph may not be constructed by using a common sense DB that has been already constructed.

Since data is manually collected in the common sense DB of the related art, there is a case where omission or missing of data occurs in the common sense DB. Accordingly, it is preferable to automatically acquire a new common sense based on the existing common sense DB and newly acquired knowledge.

According to one aspect, an object of the present disclosure is to provide a database construction program, a database construction method, and an information processing apparatus that are capable of constructing a new graph by using an already-constructed common sense DB.

A new graph may be constructed by using an already-constructed common sense DB.

Hereinafter, embodiments of a database construction program, a database construction method, and an information processing apparatus disclosed in the present application will be described in detail based on the drawings. This disclosure is not limited by the embodiments.

### Embodiment 1

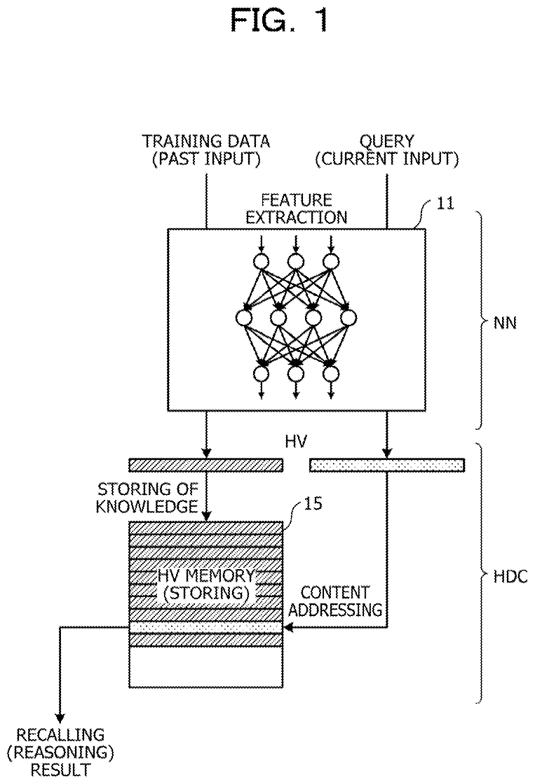

First, a related art of common sense reasoning executed by a related-art information processing apparatus will be described with reference to FIG. 1. FIG. 1 is a diagram for illustrating an example of common sense reasoning according to the related art. As illustrated in FIG. 1, in the example of common sense reasoning according to the related art, in a training phase of machine learning, the information processing apparatus inputs training data into a NN 11 and extracts a feature of the training data. The information processing apparatus generates an HV based on the extracted feature, and stores the generated HV as knowledge in an HV memory 15 in association with a label of the training data. The HV memory 15 is a content addressable memory (CAM) and recalls the label based on the HV.

At a reasoning phase of the machine learning, the information processing apparatus inputs a query into the NN 11 and extracts a feature of the query. The information processing apparatus generates an HV based on the extracted feature, specifies a label recalled based on the generated HV by using the HV memory 15, and outputs the specified label as a reasoning result.

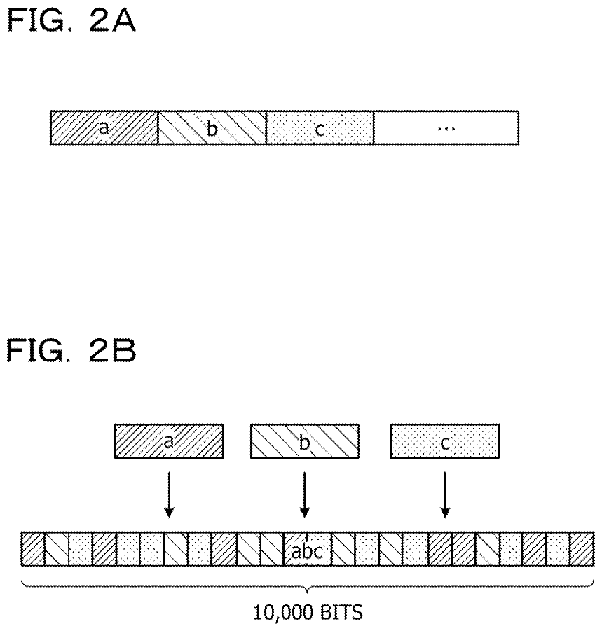

FIGS. 2A and 2B are diagrams for explaining the HV. The HV is a data representation used in HDC. The HV represents data in a distributed manner by using a hyperdimensional vector with 10,000 dimensions or more. The HV represents various types of data by using vectors having the same bit length.

As illustrated in FIG. 2A, in a normal data representation, pieces of data such as a, b, and c are each collectively represented. In contrast, as illustrated in FIG. 2B, in the hyperdimensional vector, pieces of data such as a, b, and c are each represented in a distributed manner. In the HDC, data may be manipulated by simple operations such as addition and multiplication. In the HDC, relationships between pieces of data may be represented in addition and multiplication.

However, in the case where the HV is used, there are disadvantages in terms of usage such as difficulty in interpretation of common sense and difficulty in cooperation with a common sense DB.

[Functional Configuration of Information Processing Apparatus 10]

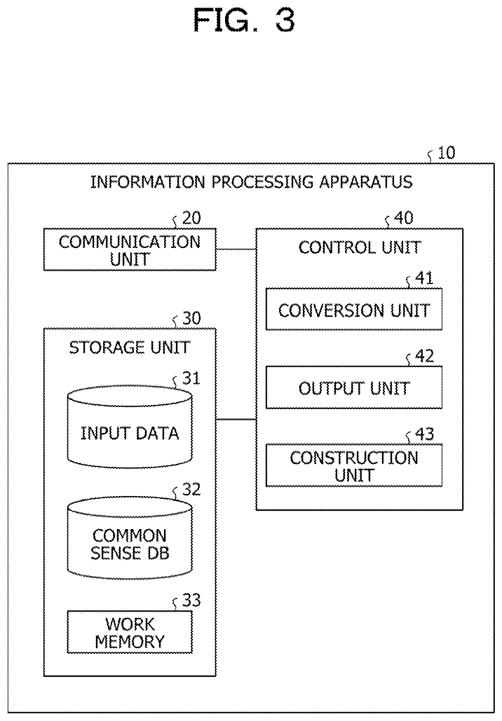

A functional configuration of an information processing apparatus 10 serving as an execution subject in the present embodiment will be described. FIG. 3 is a diagram illustrating a configuration example of the information processing apparatus 10 according to Embodiment 1. As illustrated in FIG. 3, the information processing apparatus 10 includes a communication unit 20, a storage unit 30, and a control unit 40.

For example, the communication unit 20 is a processing unit that controls communication with another information processing apparatus to and from which input data such as an image or a text and various types of data are transmitted and received, and is, for example, a communication interface such as a network interface card.

The storage unit 30 is an example of a storage device that stores various types of data and programs to be executed by the control unit 40, and is, for example, a memory, a hard disk, or the like. The storage unit 30 stores input data 31, a common sense DB 32, a work memory 33, and the like.

The input data 31 stores data to be inputted into the information processing apparatus 10 for common sense utilization. The data may be an image or a text. The data may be uploaded from another information processing apparatus to the information processing apparatus 10 via the communication unit 20, or may be read by the information processing apparatus 10 via arbitrary computer-readable recording medium.

For example, the common sense DB 32 stores combinations of parts of speech (nouns, verbs, adjectives, and the like) determined to be appropriate and types of relationships of these combinations in association with each other. As an example, the common sense DB 32 stores a combination of, for example, “human” (noun) and “draw” (verb) and “CapableOf” which is the type of relationship of this combination in association with each other. As another example, the common sense DB 32 stores a combination of “draw” (verb) and “picture” (noun) and “RelatedTo” which is the type of relationship of this combination in association with each other. The types of relationships between parts of speech are not limited to the above examples.

The work memory 33 stores subgraphs and the like of a semantic representation generated based on the input data 31.

The above-described information stored in the storage unit 30 is merely an example, and the storage unit 30 may store various types of information other than the above-described information.

The control unit 40 is a processing unit that controls the entire information processing apparatus 10, and is, for example, a processor or the like. The control unit 40 includes a conversion unit 41, an output unit 42, and a construction unit 43. Each of the processing units is an example of an electronic circuit included in the processor or an example of a process executed by the processor.

The conversion unit 41 analyzes the inputted image or text and converts the image or text into the semantic representation. For semantic representation conversion performed on a text, the conversion unit 41 uses, for example, an abstract meaning representation (AMR) parser in a related art to convert the meaning of the text into the semantic representation represented by a directed acyclic graph. The semantic representation corresponds to a semantic graph to be described later.

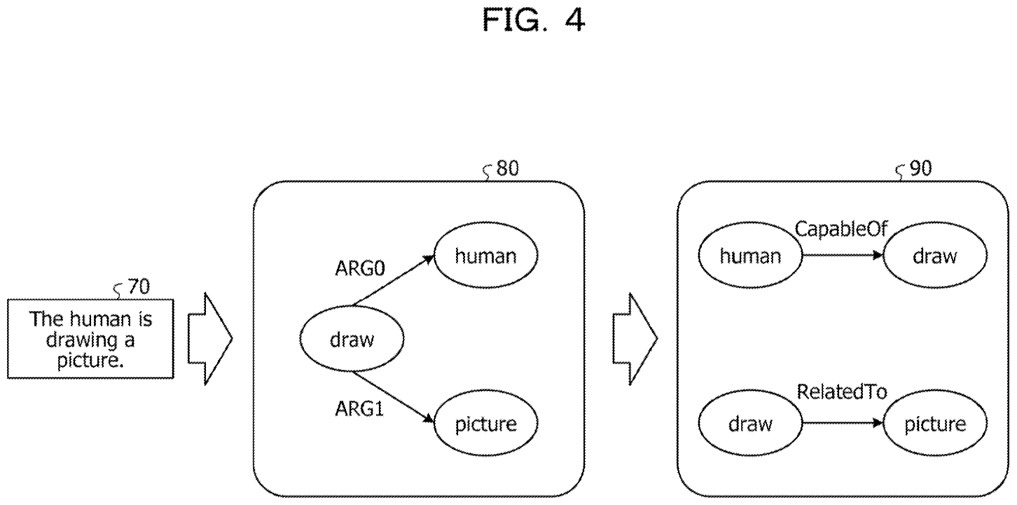

FIG. 4 is a diagram illustrating an example of the semantic graph and the subgraphs according to Embodiment 1. As illustrated in FIG. 4, a conversion unit 41 uses the AMR parser to interpret the meaning of a natural language in text data 70 and generates a semantic graph 80. The conversion unit 41 extracts subgraphs 90 from the semantic graph 80. For example, in terms of format, each subgraph 90 may be represented as a set including, as elements, a triple having a format of (“subject”, “predicate”, “object”). “Subject” represents a matter to be a subject, “object” represents a matter to be an object, and “predicate” represents a relationship between these matters. For example, the example illustrated in FIG. 4 includes triples such as (“human”, “CapableOf”, “draw”) and (“draw”, “RelatedTo”, “picture”). Such a representation format has an advantage of being easier to handle in subsequent computer process than the representation in HV.

For semantic representation conversion performed on an image, the conversion unit 41 uses, for example, a scene graph generator of a related art to generate a scene graph describing a relationship between matters included in the image and converts the image into the semantic representation based on the scene graph.

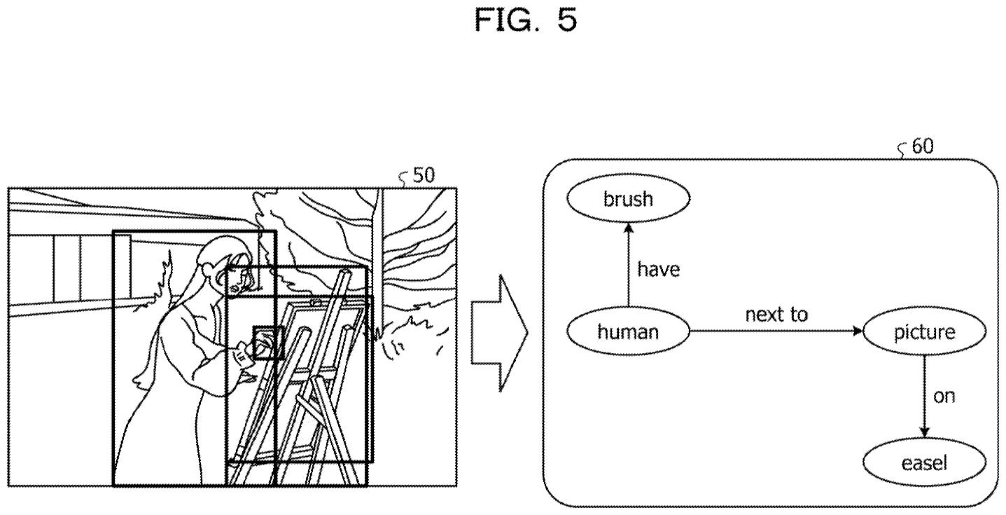

FIG. 5 is a diagram illustrating an example of a scene graph according to Embodiment 1. As illustrated in FIG. 5, the conversion unit 41 interprets the meaning of matters included in a captured image 50 by using a scene graph generator, extracts the matters as nodes and a relationship between the matters as a directed edge from the captured image 50, and generates a scene graph 60. As in the case of the text data 70 described with reference to FIG. 4, also in the case of the scene graph 60, the conversion unit 41 may convert the scene graph 60 into a triple representation having a format of (“subject”, “predicate”, “object”), for example, may extract the subgraphs from the scene graph 60. Each node in the semantic representation for the image may not be a word, and may be represented in a vector format including an image feature or the like.

The conversion unit 41 stores each subgraph of the semantic graph 80, obtained as a result of the conversion on the input data 31, in the work memory 33.

The output unit 42 outputs a validity score based on a matching degree between a first relationship of parts of speech (for example, a noun and a verb) in the semantic representation and a second relationship of parts of speech in a database stored in advance. As an example, the output unit 42 searches the common sense DB 32 for the combination of individual nodes in the subgraph converted from the image or the text data by the conversion unit 41, counts the number of matches, and outputs the count as the validity score, for example. Each of the combinations of nodes stored in the common sense DB 32 may be weighted, and the validity score may also be calculated based on the weighting.

The validity score is an example of an index indicating that the combination of the node is valid, for example, the combination is a common-sense combination, and may be used in, for example, determination of validity of a sentence. However, using the validity score as, for example, an index indicating the uniqueness of a sentence enables selection of a sentence having a novel content, a bizarre content, an outstanding opinion, or the like, which is not recognized by common sense, from collected ideas or the like.

When the validity score is less than a predetermined threshold, the output unit 42 searches the common sense DB 32 for the second relationship similar to the first relationship in the semantic representation for which there is no match, and outputs the second relationship as a correction candidate.

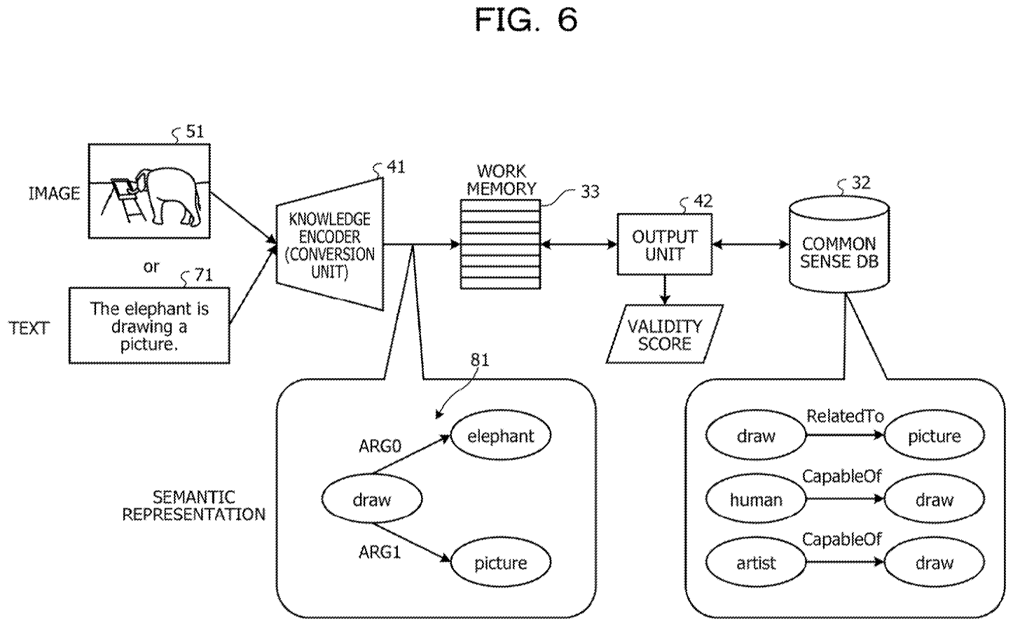

The information processing apparatus 10 that executes output process will be described with reference to FIG. 6. FIG. 6 is a diagram that illustrates an example of an overall configuration of output process according to Embodiment 1.

As illustrated in FIG. 6, first, the conversion unit 41 that is or includes a knowledge encoder converts a captured image 51 or a text data 71, inputted into the information processing apparatus 10 via another information processing apparatus or arbitrary computer-readable recording medium, to a semantic graph 81 that is the semantic representation. For example, the knowledge encoder may be the scene graph generator in the case where the captured image 51 is to be processed, or may be the AMR parser in the case where the text data 71 is to be processed. The conversion unit 41 stores the semantic graph 81 in the work memory 33.

The output unit 42 searches the common sense DB 32 based on the subgraph extracted from the semantic graph 81, and outputs the validity score based on the matching degree between a relationship of a noun and a verb in the subgraph and a relationship of a noun and a verb in the common sense DB 32.

The description returns to FIG. 3. The construction unit 43 constructs a subgraph to be a new common sense based on the subgraph of the semantic graph 81 stored in the work memory 33 and the subgraph stored in the common sense DB 32. The construction unit 43 registers the constructed subgraph in the common sense DB 32.

[Functional Details]

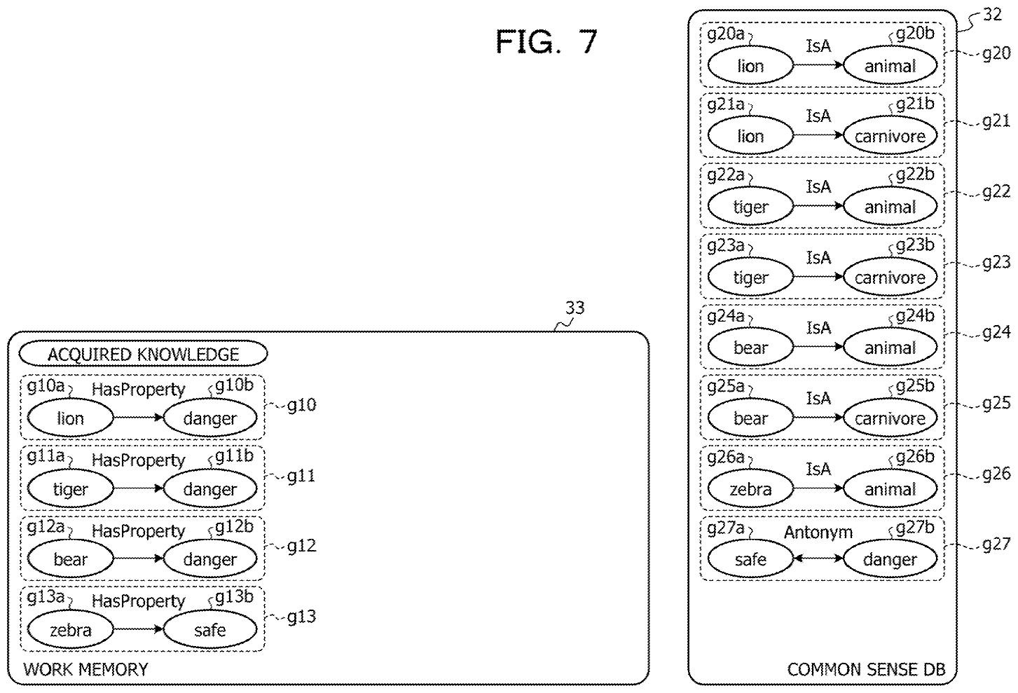

Process of constructing the subgraph to be the new common sense will be described with reference to FIGS. 7, 8, and 9. FIGS. 7 to 9 are diagrams illustrating an example of the construction process according to Embodiment 1. An execution subject of the construction process is the construction unit 43 (information processing apparatus 100). In the subgraph, nodes corresponding to parts of speech (a noun, a verb, an adjective, and the like) to which certain words are set are coupled to each other by an edge corresponding to a relationship.

FIG. 7 will be described. As a premise, subgraphs g10, g11, g12, and g13 are assumed to be stored in the work memory 33. The subgraphs g10 to g13 are subgraphs included in a semantic graph (semantic representation) stored by the conversion unit 41. The subgraphs g10 to g13 are acquired knowledge obtained from the input data 31. Hereinafter, the subgraphs g10 to g13 are collectively referred to as “acquired knowledge” as appropriate.

For example, the subgraph g10 corresponds to a set of elements of a triple (“lion”, “HasProperty”, and “danger”). In the subgraph g10, a node g10a corresponding to lion and a node g10b corresponding to danger are coupled to each other by an edge (HasProperty).

The subgraph g11 corresponds to a set of elements of a triple (“tiger”, “HasProperty”, and “danger”). In the subgraph g11, a node g11a corresponding to tiger and a node glib corresponding to danger are coupled to each other by an edge (HasProperty).

The subgraph g12 corresponds to a set of elements of a triple (“bear”, “HasProperty”, and “danger”). In the subgraph g12, a node g12a corresponding to bear and a node g12b corresponding to danger are coupled to each other by an edge (HasProperty).

The subgraph g13 corresponds to a set of elements of a triple (“zebra”, “HasProperty”, and “safe”). In the subgraph g13, a node g13a corresponding to zebra and a node g13b corresponding to safe are coupled to each other by an edge (HasProperty).

Meanwhile, subgraphs g20, g21, g22, g23, g24, g25, g26, and g27 are assumed to be stored in the common sense DB 32. The subgraphs g20 to g27 are assumed to be stored in the common sense DB 32 in advance.

For example, the subgraph g20 corresponds to a set of elements of a triple (“lion”, “IsA”, and “animal”). In the subgraph g20, a node g20a corresponding to lion and a node g20b corresponding to animal are coupled to each other by an edge (IsA).

The subgraph g21 corresponds to a set of elements of a triple (“lion”, “IsA”, and “carnivore”). In the subgraph g21, a node g21a corresponding to lion and a node g21b corresponding to carnivore are coupled to each other by an edge (IsA).

The subgraph g22 corresponds to a set of elements of a triple (“tiger”, “IsA”, and “animal”). In the subgraph g22, a node g22a corresponding to tiger and a node g22b corresponding to animal are coupled to each other by an edge (IsA).

The subgraph g23 corresponds to a set of elements of a triple (“tiger”, “IsA”, and “carnivore”). In the subgraph g23, a node g23a corresponding to tiger and a node g23b corresponding to carnivore are coupled to each other by an edge (IsA).

The subgraph g24 corresponds to a set of elements of a triple (“bear”, “IsA”, and “animal”). In the subgraph g24, a node g24a corresponding to tiger and a node g24b corresponding to animal are coupled to each other by an edge (IsA).

The subgraph g25 corresponds to a set of elements of a triple (“bear”, “IsA”, and “carnivore”). In the subgraph g25, a node g25a corresponding to bear and a node g25b corresponding to carnivore are coupled to each other by an edge (IsA).

The subgraph g26 corresponds to a set of elements of a triple (“zebra”, “IsA”, and “animal”). In the subgraph g26, a node g26a corresponding to zebra and a node g26b corresponding to animal are coupled to each other by an edge (IsA).

The subgraph g27 corresponds to a set of elements of a triple (“safe”, “Antonym”, and “danger”). In the subgraph g27, a node g27a corresponding to safe and a node g27b corresponding to danger are coupled to each other by an edge (Antonym). The “safe” corresponding to the node g27a and the “danger” corresponding to the node g27b are in a relationship of antonym.

The construction unit 43 refers to the acquired knowledge in the work memory 33, and selects a node corresponding to a word that frequently occurs among the nodes included in the acquired knowledge. For example, the construction unit 43 selects nodes that correspond to the same word and whose number is equal to or greater than a threshold, as a node that frequently occurs. The threshold is appropriately set by a user. Hereinafter, the node that frequently occurs is referred to as a “frequently-occurring node”. Assuming that the threshold is 3 in the example illustrated in FIG. 7, the construction unit 43 selects the nodes g10b, glib, and g12b corresponding to the word “danger” as the frequently-occurring node.

For the subgraphs g10, g11, and g12 including the frequently-occurring node, the construction unit 43 specifies the other nodes g10a, g11a, and g12a. In the following description, in a subgraph including the frequently-occurring node, the other node is referred to as “specified node”.

The construction unit 43 compares the specified nodes g10a, g11a, and g12a with each of the subgraphs g20 to g27 in the common sense DB 32, and specifies the subgraphs g20 to g26 having nodes of the same words as the specified nodes. For the subgraphs g20 to g26 having nodes of the same words as the specified nodes, the construction unit 43 compares the words of the other nodes and specifies nodes with the common word. Hereinafter, nodes with a common word is referred to as “common node”.

According to the example illustrated in FIG. 7, the construction unit 43 specifies the nodes g20b, g22b, and g24b common in the word “animal” as the common node. The construction unit 43 also specifies the nodes g21b, g23b, and g25b common in the word “carnivore” as the common node.

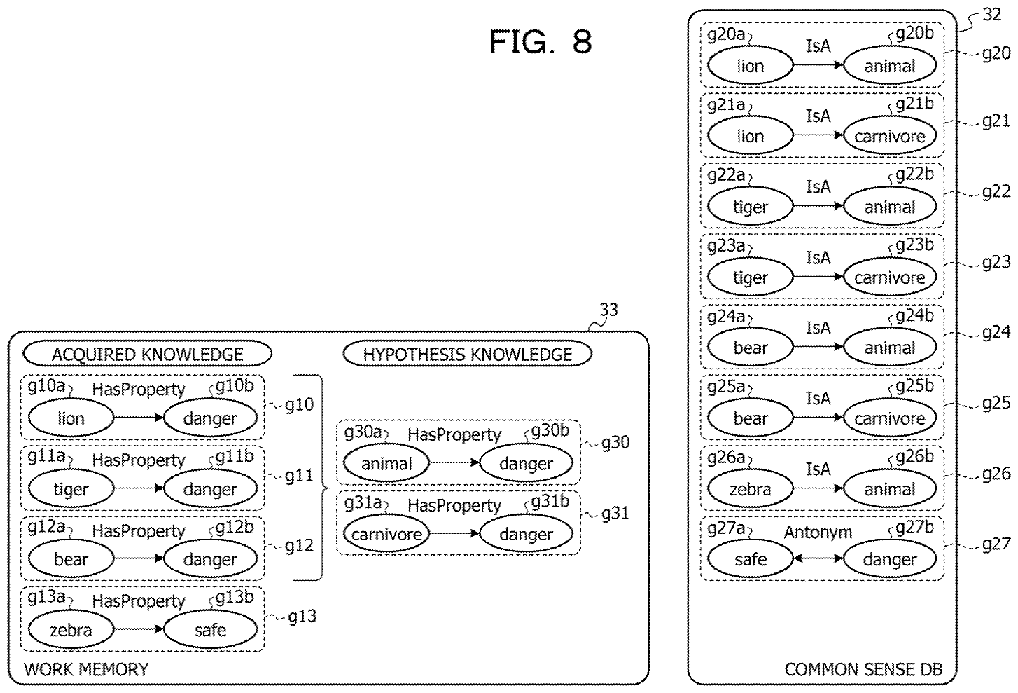

Description proceeds to FIG. 8. The construction unit 43 generates a subgraph g30 in which the specified node g10a, g11a, and g12a included in the acquired knowledge is replaced with the common node (word: animal). The construction unit 43 generates a subgraph g31 in which the specified node g10a, g11a, and g12a included in the acquired knowledge is replaced with the common node (word: carnivore). The construction unit 43 sets the subgraphs g30 and g31 as “hypothesis knowledge”.

The subgraph g30 corresponds to a set of elements of a triple (“animal”, “HasProperty”, and “danger”). In the subgraph g30, a node g30a corresponding to animal and a node g30b corresponding to danger are coupled to each other by an edge (HasProperty).

The subgraph g31 corresponds to a set of elements of a triple (“carnivore”, “HasProperty”, and “danger”). In the subgraph g31, a node g31a corresponding to carnivore and a node g31b corresponding to danger are coupled to each other by an edge (HasProperty).

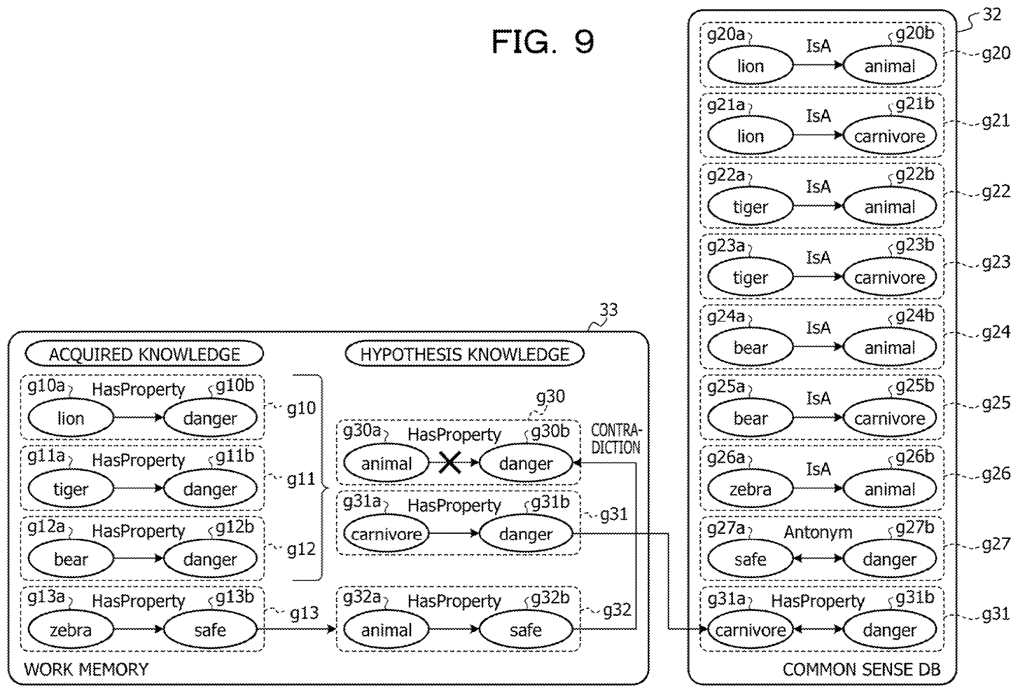

Description proceeds to FIG. 9. The construction unit 43 searches for the antonym of the specified node corresponding to danger based on the specified node and the subgraphs g20 to g27 in the common sense DB 32. For example, the construction unit 43 specifies the subgraph g27 in which the relationship of parts of speech is “Antonym” among the subgraphs g20 to g27, and specifies the node g27a that is paired with the node g27b corresponding to danger out of the nodes g27a and g27b of the specified subgraph g27. The node g27a is a node of “safe” that is the antonym of “danger”.

The construction unit 43 compares the subgraphs g10 to g13 included in the acquired knowledge with the node g27a corresponding to safe, and specifies the subgraph g13 including the node g13b corresponding to the same word “safe” as the node g27a.

Based on the node g13a of the subgraph g13 and the subgraphs g20 to g27 in the common sense DB 32, the construction unit 43 specifies the subgraph g26 including the node g26a corresponding to the same word “zebra” as the node g13a. The construction unit 43 replaces the node g13a of the subgraph g13 with the node g26b of the subgraph g26 to generate a subgraph g32.

The subgraph g32 corresponds to a set of elements of a triple (“animal”, “HasProperty”, and “safe”). In the subgraph g32, a node g32a corresponding to animal and a node g32b corresponding to safe are coupled to each other by an edge (HasProperty).

Hereinafter, the subgraph g32 is referred to as “contradiction check graph” as appropriate.

The construction unit 43 compares the subgraphs included in hypothesis knowledge with the contradiction check graph, and deletes a contradictory subgraph from the subgraphs of the hypothesis knowledge. In the example illustrated in FIG. 9, since the subgraph g30 and the subgraph g32 are in a contradictory relationship, the construction unit 43 deletes the subgraph g30 from the hypothesis knowledge.

The construction unit 43 adds the remaining hypothesis knowledge as a new common sense to the common sense DB 32. In the example illustrated in FIG. 7, the construction unit 43 adds the subgraph g31 to the common sense DB 32.

As described above, the construction unit 43 may automatically construct a subgraph that is a new common sense by executing the processing in FIGS. 7 to 9.

[Process Flow]

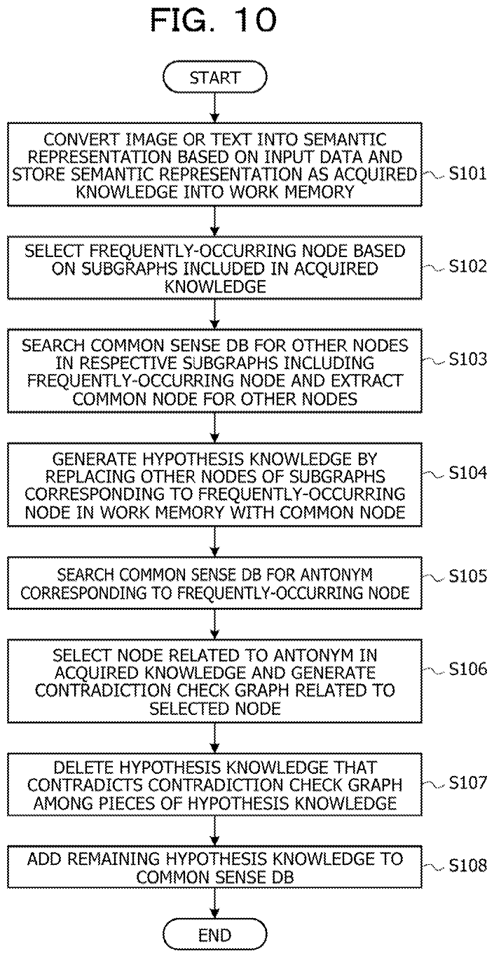

Next, a flow of a construction process by the information processing apparatus 10 will be described with reference to FIG. 10. FIG. 10 is a flowchart illustrating an example of the flow of the construction process according to Embodiment 1. The construction process illustrated in FIG. 10 may be started by being triggered by an operation such as upload of an image or text to be processed to the information processing apparatus 10, or may be started at arbitrary timing.

The conversion unit 41 of the information processing apparatus 10 converts an image or a text to the semantic representation based on the input data 31 and stores the semantic representation as the acquired knowledge in the work memory 33 (step 8101).

The construction unit 43 of the information processing apparatus 10 selects the frequently-occurring node based on the subgraphs included in the acquired knowledge (step S102). The construction unit 43 searches the common sense DB 32 for the other nodes in the respective subgraphs including the frequently-occurring node and extracts the common node for the other nodes (step S103).

The construction unit 43 replaces the other nodes of the subgraphs corresponding to the frequently-occurring node in the work memory 33 with the common node to generate the hypothesis knowledge (step S104). The construction unit 43 searches the common sense DB 32 for an antonym corresponding to the frequently-occurring node (step S105).

The construction unit 43 selects a node related to the antonym in the acquired knowledge in the work memory 33, and generates the contradiction check graph related to the selected node (step S106). The construction unit 43 deletes the hypothesis knowledge that contradicts the contradiction check graph, among pieces of the hypothesis knowledge (step S107). The construction unit 43 adds the remaining hypothesis knowledge to the common sense DB 32 (step S108).

[Effects]

As described above, the information processing apparatus 10 generates the hypothesis knowledge based on the subgraphs included in the semantic representation generated based on the input data 31 and the subgraphs registered in the common sense DB 32 in advance, deletes a hypothesis including a contradiction from the hypothesis knowledge, and registers the remaining hypothesis knowledge in the common sense DB 32.

Accordingly, it is possible to automatically acquire a new common sense based on the existing common sense DB 32 and newly acquired knowledge.

The information processing apparatus 10 refers to the acquired knowledge in the work memory 33 and selects the frequently-occurring node corresponding to a frequently occurring word among the nodes in the acquired knowledge. The information processing apparatus 10 extracts the common node based on the frequently-occurring node and the subgraphs in the common sense DB 32, replaces the nodes in the acquired knowledge with the common node, and generates the hypothesis knowledge.

Accordingly, it is possible to automatically create the hypothesis knowledge that is a candidate for a new common sense, based on the existing common sense DB 32 and the newly acquired knowledge.

The information processing apparatus 10 specifies the contradictory subgraph among the plurality of subgraphs included in the hypothesis knowledge based on the relationship of parts of speech that is the antonym and that is stored in the common sense DB 32.

Accordingly, it is possible to specify a non-contradictory hypothesis from the hypothesis knowledge.

[System]

Unless otherwise specified, process procedures, control procedures, specific names, and information including various types of data and parameters described above in the document and the drawings may be arbitrarily changed. The specific examples, distributions, numerical values, and so forth described in the embodiment are merely exemplary and may be arbitrarily changed.

Each of the illustrated elements of each of the apparatuses is a functional concept and does not have to be physically configured as illustrated. For example, specific forms of distribution and integration of each of the apparatuses are not limited to those illustrated. For example, all or part of the apparatus may be configured to be functionally or physically distributed or integrated in arbitrary units depending on various types of loads, usage states, or the like. All or arbitrary of the process functions performed by each apparatus may be implemented by a central processing unit (CPU), a graphics processing unit (GPU), and a program to be analyzed and executed by the CPU or the GPU, or may be implemented as hardware using wired logic.

[Hardware]

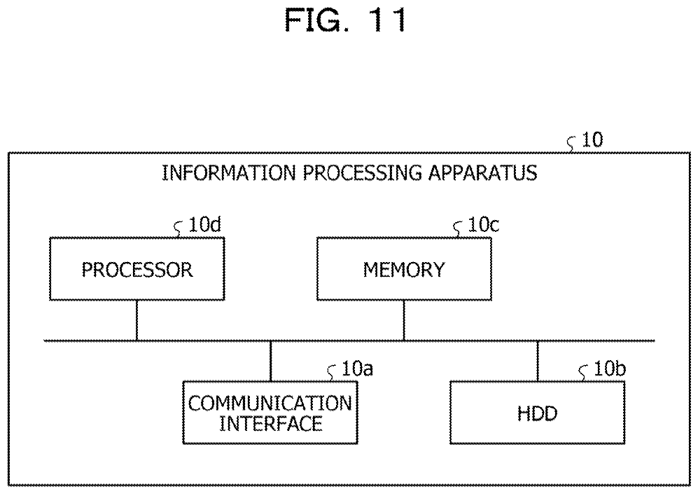

FIG. 11 is a diagram for explaining a hardware configuration example. As illustrated in FIG. 11, the information processing apparatus 10 includes a communication interface 10a, a hard disk drive (HDD) 10b, a memory 10c, and a processor 10d. The components illustrated in FIG. 11 are coupled to one another by a bus or the like.

The communication interface 10a is a network interface card or the like and performs communication with other servers. The HDD 10b stores the DB and the program for operating the functions illustrated in FIG. 3.

The processor 10d is a hardware circuit that reads, from the HDD 10b or the like, the program for executing processes similar to those of the respective processing units illustrated in FIG. 3 and loads the program to the memory 10c to operate process of executing each of the functions illustrated in FIG. 3 and the like. For example, in this process, functions similar to those of the respective processing units included in the information processing apparatus 10 are executed. For example, the processor 10d reads a program having functions similar to those of the conversion unit 41, the output unit 42, the construction unit 43, and the like from the HDD 10b or the like. The processor 10d executes process in which processes similar to those of the conversion unit 41, the output unit 42, the construction unit 43, and the like are executed.

As described above, the information processing apparatus 10 operates as an information processing apparatus that executes an operation control process by reading and executing the program configured to execute the processes similar to those of the respective processing units illustrated in FIG. 3. The information processing apparatus 10 may also achieve the functions similar to the functions of the above-described embodiment by reading the program from a recording medium with a medium reading device and executing the read program. Programs described in other embodiments are not limited to a program executed by the information processing apparatus 10. For example, the present embodiment may be similarly applied to the case where another computer or a server executes the program or the other computer and the server cooperate with each other to execute the program.

The program for executing the processes similar to those of the respective processing units illustrated in FIG. 3 may be distributed through a network such as the Internet. The program may be recorded on a computer-readable recording medium such as a hard disk, a flexible disk (FD), a compact disc read-only memory (CD-ROM), a magneto-optical (MO) disk, or a Digital Versatile Disc (DVD) and may be executed by being read from the recording medium by a computer.

### Embodiment 2

While the example of the present disclosure has been described, the present disclosure may be implemented in various different forms other than Embodiment 1 described above.

Although the information processing apparatus 10 acquires a new common sense by distinguishing between the acquired knowledge and the existing common sense DB 32 in Embodiment 1, a new common sense may be acquired by using only the common sense DB 32. In this case, there is no distinction between the work memory 33 and the common sense DB 32. For example, the information processing apparatus 10 starts a process in a state where the subgraphs g10 to g13 described with reference to FIG. 7 and the like are stored in the common sense DB 32, and generates a new subgraph g31.

Although description is given that the information processing apparatus 10 uses the antonym as the relationship used to derive the contradiction in Embodiment 1, the present disclosure is not limited to this, and the contradiction may be derived by using a relationship such as “DistinctiFrom” instead of the antonym.

Although each node in the semantic representation is indicated by a word in Embodiment 1, the present disclosure is not limited to this, and knowledge represented in a vector format including an image feature may be used.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a database construction program that causes at least one computer to execute a process, the process comprising:
analyzing an input image or text to generate a semantic representation including a plurality of subgraphs defining relationships between a plurality of first parts of speech and a plurality of second parts of speech;
extracting, from a plurality of subgraphs stored in a database, third parts of speech having relationships with the first parts of speech included in the plurality of subgraphs of the semantic representation;
generating first knowledge including a plurality of subgraphs in which the first parts of speech in the plurality of subgraphs of the semantic representation are replaced with the third parts of speech; and
registering, in the database, a remaining subgraph obtained by removing a contradictory subgraph from the plurality of subgraphs included in the first knowledge based on the semantic representation and the database.

2. The non-transitory computer-readable storage medium according to claim 1, wherein
a word is set for each of the parts of speech, and
the process further comprising
selecting, as a frequently-occurring part of speech, one of the second parts of speech of the word that more frequently occurs than the second parts of speech of other words among the plurality of second parts of speech included in the plurality of subgraphs in the semantic representation, wherein
the extracting includes extracting, as the third parts of speech, parts of speech of words that each have a relationship with the frequently-occurring part of speech and that are each in common with other subgraphs, based on the plurality of subgraphs included in the database.

3. The non-transitory computer-readable storage medium according to claim 2, wherein
the database further stores a relationship of parts of speech that are antonyms of each other, and
the registering includes specifying a contradictory subgraph among the plurality of subgraphs included in the first knowledge, based on the relationship of the parts of speech that are antonyms of each other.

4. The non-transitory computer-readable storage medium according to claim 3, wherein the specifying includes:
specifying an antonym of the frequently-occurring part of speech based on the database;
extracting, from the database, a fourth part of speech that is the first part of speech having a relationship with the antonym of the frequently-occurring part of speech among the plurality of the first parts of speech included in the semantic representation and that has a relationship with the third part of speech; and
specifying a contradictory subgraph among the plurality of subgraphs included in the first knowledge based on a relationship between the fourth part of the speech and the antonym of the frequently-occurring part of speech.

5. A database construction method for a computer to execute a process comprising:
analyzing an input image or text to generate a semantic representation including a plurality of subgraphs defining relationships between a plurality of first parts of speech and a plurality of second parts of speech;
extracting, from a plurality of subgraphs stored in a database, third parts of speech having relationships with the first parts of speech included in the plurality of subgraphs of the semantic representation;
generating first knowledge including a plurality of subgraphs in which the first parts of speech in the plurality of subgraphs of the semantic representation are replaced with the third parts of speech; and
registering, in the database, a remaining subgraph obtained by removing a contradictory subgraph from the plurality of subgraphs included in the first knowledge based on the semantic representation and the database.

6. The database construction method according to claim 5, wherein
a word is set for each of the parts of speech, and
the process further comprising
selecting, as a frequently-occurring part of speech, one of the second parts of speech of the word that more frequently occurs than the second parts of speech of other words among the plurality of second parts of speech included in the plurality of subgraphs in the semantic representation, wherein
the extracting includes extracting, as the third parts of speech, parts of speech of words that each have a relationship with the frequently-occurring part of speech and that are each in common with other subgraphs, based on the plurality of subgraphs included in the database.

7. The database construction method according to claim 6, wherein
the database further stores a relationship of parts of speech that are antonyms of each other, and
the registering includes specifying a contradictory subgraph among the plurality of subgraphs included in the first knowledge, based on the relationship of the parts of speech that are antonyms of each other.

8. The database construction method according to claim 7, wherein the specifying includes:
specifying an antonym of the frequently-occurring part of speech based on the database;
extracting, from the database, a fourth part of speech that is the first part of speech having a relationship with the antonym of the frequently-occurring part of speech among the plurality of the first parts of speech included in the semantic representation and that has a relationship with the third part of speech; and
specifying a contradictory subgraph among the plurality of subgraphs included in the first knowledge based on a relationship between the fourth part of the speech and the antonym of the frequently-occurring part of speech.

9. An information processing apparatus comprising:
one or more memories; and
one or more processors coupled to the one or more memories and the one or more processors configured to:
analyze an input image or text to generate a semantic representation including a plurality of subgraphs defining relationships between a plurality of first parts of speech and a plurality of second parts of speech,
extract, from a plurality of subgraphs stored in a database, third parts of speech having relationships with the first parts of speech included in the plurality of subgraphs of the semantic representation,
generate first knowledge including a plurality of subgraphs in which the first parts of speech in the plurality of subgraphs of the semantic representation are replaced with the third parts of speech, and
register, in the database, a remaining subgraph obtained by removing a contradictory subgraph from the plurality of subgraphs included in the first knowledge based on the semantic representation and the database.

10. The information processing apparatus according to claim 9, wherein
a word is set for each of the parts of speech, and
the one or more processors are further configured to:
select, as a frequently-occurring part of speech, one of the second parts of speech of the word that more frequently occurs than the second parts of speech of other words among the plurality of second parts of speech included in the plurality of subgraphs in the semantic representation, and
extract, as the third parts of speech, parts of speech of words that each have a relationship with the frequently-occurring part of speech and that are each in common with other subgraphs, based on the plurality of subgraphs included in the database.

11. The information processing apparatus according to claim 10, wherein
the database further stores a relationship of parts of speech that are antonyms of each other, and
the one or more processors are further configured to
specify a contradictory subgraph among the plurality of subgraphs included in the first knowledge, based on the relationship of the parts of speech that are antonyms of each other.

12. The information processing apparatus according to claim 11, wherein the one or more processors are further configured to:
specify an antonym of the frequently-occurring part of speech based on the database,
extract, from the database, a fourth part of speech that is the first part of speech having a relationship with the antonym of the frequently-occurring part of speech among the plurality of the first parts of speech included in the semantic representation and that has a relationship with the third part of speech, and
specify a contradictory subgraph among the plurality of subgraphs included in the first knowledge based on a relationship between the fourth part of the speech and the antonym of the frequently-occurring part of speech.
